(19) United States
(12) Patent Application Publication
(10) Pub. No.: US 2015/0064434 A1
(43) Pub. Date: Mar. 5, 2015

(54) Multilayer Surface Covering

(71) Applicant: TARKETT GDL, Lentzweiler (LU)

(72) Inventors: Pierre Bastin, Wiltz (LU); Pascal Di Croce, Wiltz (LU)

(21) Appl. No.: 14/388,367

(22) PCT Filed: Mar. 18, 2013
(86) PCT No.: PCT/EP2013/055580

§ 371 Date: Sep. 26, 2014

(30) Foreign Application Priority Data
Mar. 28, 2012 (EP) 12161780.7

(51) Int. Cl. B32B 9/04; B32B 37/12; B32B 37/04

(52) U.S. Cl. CPC B32B 9/047; B32B 37/04; B32B 37/12; B32B 2260/021; B32B 2250/02; B32B 2471/00
USPC 428/219; 156/322; 156/324.4

(57) ABSTRACT

The present invention relates to a multilayer surface covering (1) comprising a fibre veil (3) having a specific weight comprised between 17 to 75 g/m² on the side intended to contact, in use, the surface to cover, said fibre veil (3) comprising a polyolefin-based binder impregnation at a weight comprised between 5 to 25 g/m².

### FIELD OF THE INVENTION

The present invention relates to a multilayer PVC-free surface covering comprising a fibre veil on its back surface which is intended to contact the surface to cover. It relates also to a method for producing such a multilayer PVC-free surface covering and a method for covering a surface with such a multilayer PVC-free surface covering.

### PRIOR ART AND RELATED TECHNICAL BACKGROUND

Surface coverings are widely used to cover buildings or houses surfaces as they are more pleasant, more aesthetic and more comfortable than a surface just painted.

Among surface coverings, and particularly floor coverings, carpets and multilayer surface coverings are well known.

Carpets are textile, or fibers-based, floor coverings comprising an upper layer called “pile”, which is the visible wear surface, made of natural or synthetic yarn or fibres, woven together or tufted on a support layer.

Multilayer surface coverings are non-fibres-based coverings. They are generally made of a plurality of polymer-based layers, sheets or films, laid one over the others.

PVC-based multilayer surface coverings are well known; However due to environmental issues regarding VOC (Volatile Organic Compounds) release, efforts on PVC alternatives were developed and PVC-free surface coverings were proposed, among which polyolefin-based surface coverings.

Generally, multilayer surface coverings comprise a “support layer” and an upper layer known as “wear layer”, with optionally a decorative layer between the support layer and the wear layer and/or varnish layer as top coating.

Despite the fact that multilayer surface coverings may comprise a non-woven fiberglass mat embedded into the support layer, they may further comprise a woven or non-woven mat, having a thickness of several millimetres, on the back side of the support layer, i.e. on the surface intended to contact the surface to cover, to provide improved dimensional stability, strength, better insulating and acoustic properties.

Multilayer surface coverings are generally laid on the surface to cover by means of a glue which is adapted to the nature of the support layer of the surface covering.

For PVC-based coverings, the glue is generally an acrylic-based glue.

For PVC-free surface coverings, a PVC-based coverings compatible glue, in particular acrylic-based glue, is not suitable because of adhesion issues with the support layer of PVC-free surface coverings.

Regarding multilayer surface coverings comprising a woven or non-woven mat on the back side of support layer, they are generally not glued on the surface to cover to maintain the stability, strength, insulating and acoustic properties provided by the woven or non-woven mat.

### AIMS OF THE INVENTION

The present invention aims to provide a multilayer PVC-free a surface covering, and a method for covering a surface with such surface covering, which do not have the drawbacks of the prior.

The present invention aims to provide a PVC-free multilayer surface covering having an improved adherence with the surface to cover.

The invention aims to provide a multilayer PVC-free surface covering which may be applied to the surface to cover with a large number of glue types, particularly with PVC compatible glues, i.e. glues used to fasten PVC-free surface coverings.

### SUMMARY OF THE INVENTION

The present invention discloses a multilayer PVC-free surface covering comprising a PVC-free support layer comprising a fibre veil having a specific weight comprised between 17 to 75 g/m² on the side intended to contact, in use, the surface to cover, said fibre veil comprising a polyolefin-based binder impregnation at a weight comprised between 5 to 25 g/m².

According to particular embodiments, the multilayer PVC-free surface covering may comprise one, or a suitable combination of one or several, of the following characteristics:

the weight ratio of the binder composition/weight of the fibre veil 3 is comprised between 0.13 and 0.625, preferably between 0.2 to 0.375,

the polyolefin-based binder impregnation comprises high density polyethylene (HDPE), low density polyethylene (LDPE) or linear low density polyethylene (LLDPE), very Low Density Polyethylene (VLDPE), ethylene vinyl acetate (EVA), polyolefin plastomers (POP), polyolefin elastomers (POE) or a combination thereof,

the fibre veil comprising the polyolefin-based binder impregnation has a thickness of less than 350 μm, preferably less than 250 μm,

the PVC-free support layer is a polyolefin-based layer,

the PVC-free support layer comprises a composition comprising ethylene vinyl acetate (EVA), ethyl methyl acrylate (EMA), ethylene butyl acrylate (EBA), very low density polyethylene (VLDPE), linear low density polyethylene (LLDPE), polyolefin plastomers (POP), polyolefin elastomers (POE) or a combination thereof,

the multilayer PVC-free surface covering comprises a decorative layer comprising a polyurethane water-based ink, and a polyolefin-based wear layer,

the multilayer PVC-free surface covering comprises a polyurethane-based varnish layer over a polyolefin-based wear layer.

The present invention relates to the use of a fibre veil having a specific weight comprised between 17 to 75 g/m², and comprising a polyolefin-based binder impregnation at a weight comprised between 5 to 25 g/m², to enhance the roughness of the back surface of a PVC-free support layer or a surface covering comprising said a support layer.

The present invention relates also to the use of a fibre veil having a specific weight comprised between 17 to 75 g/m², and comprising a polyolefin-based binder impregnation at a weight comprised between 5 to 25 g/m², to make a PVC-free support layer of a multiple layer PVC-free surface covering compatible with a PVC compatible glue, preferably an acrylic-based glue.

The present invention relates to a method for producing the surface multiple layer PVC-free surface covering according to the invention, said method comprising the steps of providing a fibre veil having a specific weight comprised between 17 to 75 g/m² and impregnated with a polymer-based binder composition at a weight comprised between 5 to 25 g/m² or providing a fibre veil having a specific weight comprised between 17 to 75 g/m² and spreading a polymer-based binder composition at a weight comprised between 5 to 25 g/m² over one side of said fibre veil, providing a PVC-free support layer or a multiple layer PVC-free surface covering comprising a PVC-free support layer, submitting to heat, or heat and pressure, the fibre veil comprising the polymer-based binder composition before being, or simultaneously while being, brought into contact to the support layer or the support layer of multiple layer PVC-free surface covering.

The method for producing the multiple layer PVC-free surface covering according to the invention may comprises the step of submitting to heat the fibre veil comprising the polymer-based binder composition simultaneously while being put in contact with the support layer and simultaneously while the wear layer is brought into contact to the support layer.

In a preferred embodiment of the method for producing the multiple layer PVC-free surface covering according to the invention, the heating temperature is comprised between 90 and 170° C. and the pressure is comprised between 0.25 and 5 bars.

The present invention relates to a method for covering a surface, the method comprising the steps of providing a PVC compatible glue, providing a multiple layer PVC-free surface covering according to the invention, applying said PVC compatible glue at a concentration comprised between 150 and 500 g/m² over the surface to cover to form a glue layer having a thickness comprised between 100 and 400 μm, applying said multiple layer PVC-free surface covering over said PVC compatible glue.

In a preferred embodiment of the method for covering a surface according to the invention the time between the step of applying the PVC compatible glue and applying the multiple layer PVC-free surface covering should not exceed 15 minutes.

### BRIEF DESCRIPTION OF THE DRAWINGS

FIG. 1 represents schematically a first embodiment of the surface covering according to the invention.

FIG. 2 represents schematically a second embodiment of the surface covering according to the invention.

FIG. 3 represents schematically a third embodiment of the surface covering according to the invention.

### DETAILED DESCRIPTION OF THE INVENTION

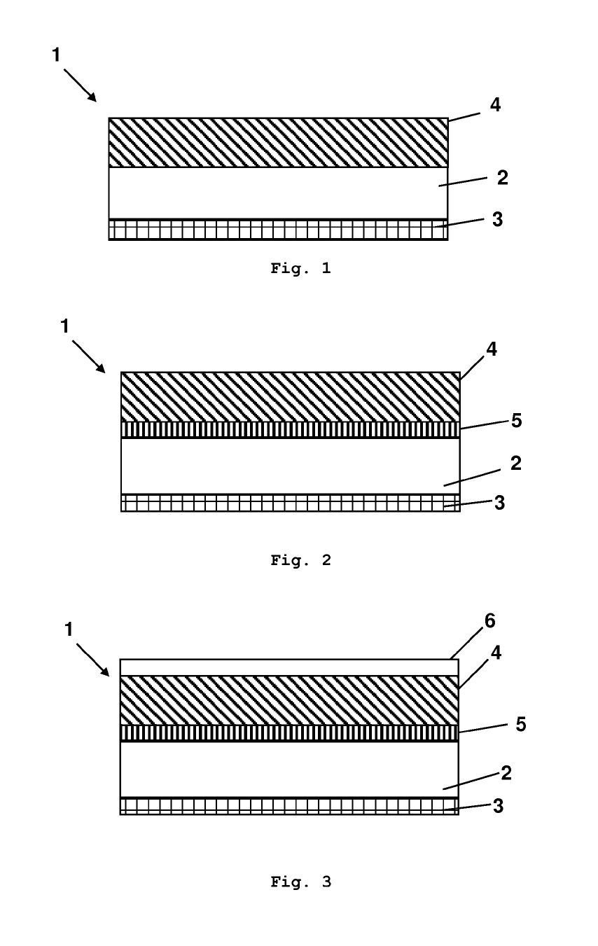

The multilayer PVC-free surface covering 1 comprises a support layer 2 (FIG. 1) being a PVC-free layer comprising a thermoplastic composition.

In a preferred embodiment, the thermoplastic composition comprises a polyolefin resin or a combination of polyolefin resins.

Preferably, the polyolefin resin is ethylene vinyl acetate (EVA), ethyl methyl acrylate (EMA), ethylene butyl acrylate (EBA), very low density polyethylene (VLDPE), linear low density polyethylene (LLDPE), polyolefin plastomers (POP), polyolefin elastomers (POE) or a combination thereof.

Concerning the definition of POE and POP we refer to the “Handbook of Plastics Elastomers and Composites, Charles A. Harper, 4th edition, Mc Graw-Hill Handbooks, p 195. Elastomer and plastomer resins are defined as being elastomer when the content of octene monomer is less than 20%, and as being plastomer when the content of octene monomer is more than 20%. However, the POE and POP according to the invention may also be the ones obtained by replacing octene monomers by butene or hexene co-monomers.

The polyolefin elastomer or plastomers are disclosed in U.S. Pat. No. 5,272,236 and U.S. Pat. No. 5,278,272, the disclosures of which are incorporated herein by reference.

Preferably, the polyolefin resin has a Melt Flow Index (MFI) comprised between 2 and 400 g/10 min (at 190° C. under 2.16 kg weight).

Preferably, VLDPE has a density range of 0.880 to 0.915 g/cm³ (ASTM D792), LLDPE a density range of 0.915 to 0.925 g/cm³(ASTM D792), POEs or POPs a density of 0.87 to 0.902 g/cm³ (ASTM D792).

In a preferred embodiment, the composition of the support layer 2 comprises a polyolefin elastomer having a density of around 0.88 g/cm³ and a Melt Flow Index (MFI) of 2 g/10 min (at 190° C. under 2.16 kg weight).

In another preferred embodiment, the composition of the support layer 2 is the one disclosed in PCT/EP2009/065993, which is incorporated by referencehereinto.

In another preferred embodiment, the composition of the support layer 2 comprises at least one second polymer. Said second polymer comprises acid anhydride groups and represents at least 5 parts in weight, or 5% wt, preferably between 10 to 40 parts in weight, per 100 parts of the total amount of polymers.

The polymer comprising acid anhydride groups may be, for example, a polyethylene incorporating maleic anhydride monomers and having a density of around 0.94 g/cm³ and a MFI (at 190° C. under 2.16 kg weight) of around 25 g/10 min, or a terpolymer of ethylene, butyl-acrylate and maleic anhydride, said terpolymer having a density of around 0.94 g/cm³ and a MFI (at 190° C. under 2.16 kg weight) of around 5 g/10 min, or a polyolefin plastomer or elastomer, obtained by a metallocene catalysis and chemically modified to incorporate maleic anhydride, and having a density of around 0.88 g/cm³ and a MFI (at 190° C. under 2.16 kg weight) of around 3.7 g/10 min, or an EVA polymer chemically modified to incorporate maleic anhydride, and having a density of around 0.96 g/cm³ and a MFI (at 190° C. under 2.16 kg weight) of around 1.4 g/10 min.

In a preferred embodiment, the composition of the support layer 2 comprises 30% wt of VLDPE having a density of 0.9 g/cm³ and a MFI of 3 g/10 min, 30% wt of POE having a density of 0.87 g/cm³ and a MFI of 1 g/10 min, 30% wt of EVA having around 18% of vinyl acetate and a MFI of 2 g/10 min and 10% wt of POE comprising anhydride groups, having a density of 0.87 g/cm³ and a MFI of 3.7 g/10 min, the percentage in weight being based on the total amount of the polyolefin resins and the MFI being measured at 190° C. under 2.16 kg weight.

Preferably, the composition of the support layer 2 further comprises at least 100 parts of at least one filler per 100 parts of the total amount of polymer or polymers.

The filler is preferably a mineral filler, for example CaCO₃, MgCO₃, CaMgCO₃, Si0₂, silicates, barium sulphates, alumina hydrates, magnesium hydrates or zinc borates.

The support layer 2 may also comprise additives such as thermal or light stabilizers, antistatic additives, processing additives, the type and the quantity of these additives being adapted to the process in particular to the type and quantity of component of the layer composition.

The surface covering 1 may further comprise a glass veil to provide dimensional stability to the support layer 2. The glass veil may be embedded in the support layer 2.

The support layer 2 has a thickness comprised between 500 and 3700 μm, more preferably around 1700 μm.

The multilayer PVC-free surface covering 1 comprises a fibre veil 3 on the surface of the support layer 2 intended to contact and give a better grip to the surface to be covered.

The fibre veil 3 may comprise single-component and/or bi-component fibres.

The fibres forming the fibre veil 3 may be natural, animal or vegetal fibres, synthetic fibres or a combination thereof. They may be made of jute, cotton, wool, or being cellulosic fibers. They may be made of polyester, polyamide, polyethylene or polypropylene. In a preferred embodiment, the fibers have a polyester-based core surrounded by a polyamide-based Sheath.

The fibre veil 3 comprises fibres having a diameter comprised between 15 and 50 μm and a length higher than 1 cm.

Preferably, the fibre veil 3 has a specific weight comprised between 17 to 75 g/m², more preferably between 25 and 50 g/m².

Preferably, the fibre veil 3 has a thickness comprised between 50 to 300 μm.

The fibre veil 3 further comprise a binder composition, preferably a polymer-based binder, allowing bounding the fibres together and allowing also improving the adhesion with the support layer 2.

The binder composition comprises preferably high density polyethylene (HDPE), low density polyethylene (LDPE) or linear low density polyethylene (LLDPE), Very Low Density Polyethylene (VLDPE), ethylene vinyl acetate (EVA), polyolefin plastomers (POP), polyolefin elastomers (POE) or a combination thereof.

The fibre veil 3 is impregnated with the binder composition at a concentration comprised between 5 to 25 g/m², more preferably between 10 and 15 g/m².

Preferably, the weight ratio of the binder composition/weight of the fibre veil 3 is comprised between 0.13 and 0.625. Preferably, the weight ratio is comprised between 0.2 to 0.375, more preferably between 0.266 to 0.333.

Preferably, the binder composition is a powder. In this embodiment, the powder is preferably spread using any suitable device over at least one side of the fibre veil 3.

Preferably, the thickness of the fibre veil 3 comprising the binder composition as a powder, before being submitted to heat, or heat and pressure, is comprised between 80 μm to 350 μm.

The cohesion of the fibres of the fibre veil 3 is obtained by submitting the impregnated fibre veil 3 to heat, at a temperature above the melting point of the binder composition, or to heat and pressure, preferably between 90 and 170° C., preferably between 0.25 and 5 bars, preferably during 10 to 60 seconds, using any suitable device.

The heat allow the melted binder composition to penetrate through 35 to 70% of the fibre veil thickness.

The thickness of the fibre veil 3 comprising the melted binder composition depends on the specific weight of the fibres and the amount of binder composition; however, the impregnated fibre veil 3 has a thickness comprised between 80 and 350 μm.

The binder composition has the advantage of providing simultaneously adhesion between the fibres within the fibre veil 3 and adhesion of the fibre veil 3 to the support layer 2.

It further provides the advantage of being easily processed as it avoids the fibre veil 3 to stick to hot metal devices during the production of the multiple layer surface covering.

The use of a fibre veil 3 enhances the roughness of the back surface of a PVC-free support layer 2 or a surface covering comprising such a support layer 2.

The use of the fibre veil 3 makes a PVC-free support layer 2 of a multilayer PVC-free surface covering 1 compatible with a PVC compatible glue, i.e. a glue used to fasten a PVC-based surface covering to a surface to cover.

The use of the fibre veil 3 makes a PVC-free support layer 2 of a multilayer PVC-free surface covering 1 compatible with an acrylic-based glue.

The multilayer PVC-free surface covering 1 comprises a wear layer 4 laid over the support layer 2 or over a decorative layer 5 if any.

The wear layer 4 is made of any suitable composition which is compatible with the support layer 2 composition, and decorative layer 5 composition if any.

The wear layer 4 is either a monolayer or multilayer based on an acid polymer, preferably based on ethylene methacrylic acid or ethylene acrylic acid co-monomer or terpolymer.

Preferably, the wear layer 4 is a multiple layer of a non-neutralized acid polymer.

However, the wear layer 4 could also be a monolayer or multilayer based on an acid polymer neutralized or partially neutralised to form an ionomer.

The wear layer 4, being either a monolayer or a multilayer, has a thickness comprised between 100 and 800 μm, preferably between 150 and 300 μm.

Depending on the wear properties the wear layer 4 should have, each layer, forming the wear layer 4 in the multilayer embodiment, could have a thickness comprised between 100 and 800 μm.

The surface covering 1 may further comprise a decorative layer 5 between the support layer 2 and the wear layer 4 (FIG. 2). In this embodiment, the wear layer 4 is substantially transparent.

The decorative layer 5 is made of a single composition or made of several compositions. The decorative layer 5 composition, or compositions, comprise any suitable pigment or pigments combination. Preferably, the composition is an ink, preferably a polyolefin compatible ink or a composition comprising such inks. More preferably, it is a water-based ink. For example, the ink is polyurethane water-based ink.

The decorative layer 5 may comprise one or several layers, successive layers, of the above mentioned composition or compositions.

The surface covering 1 according to the invention may further comprise over the wear layer 4, a varnish layer 6 (FIG. 3).

Preferably, the composition of the varnish layer 6 comprises curable polyurethane which is cured by UV and/or by heat, to form a three-dimensional structure allowing to get the wear and stain resistance properties.

The varnish layer 6 has preferably a thickness comprised between 5 and 25 μm.

The surface covering according to the invention may be a wall or a floor covering.

The method to produce the multilayer PVC-free surface covering according to the invention comprise the step of providing a fibre veil 3 and spreading a polymer-based binder composition over one side of said fibre veil 3, or providing a fibre veil 3 impregnated with a polymer-based binder composition and providing a PVC-free support layer 2 or a multiple layer PVC-free surface covering 1 comprising a PVC-free support layer 2. The fibre veil 3 comprising the polymer-based binder composition is submitted to heat, or heat and pressure, before being or simultaneously while being brought into contact to the support layer 2 or the support layer 2 of multiple layer PVC-free surface covering 1.

Preferably, the bounding of the fibres to each other in the fibre veil 3 is preferably simultaneous to the adhesion of the fibre veil 3 to the support layer 2.

In the embodiment wherein a PVC-free support layer 2 is provided and not a multiple layer PVC-free surface covering 1, the method further comprise the steps of applying, over the opposite surface of the support layer 2 comprising the fibre veil 3, a wear layer 4, or a decorative layer 5 and a wear layer 4, and optionally a varnish layer 6 over the wear layer.

In a preferred embodiment, the fibre veil 3 comprising the polymer-based binder composition is submitted to heat simultaneously while being put in contact with the support layer 2 and simultaneously while the wear layer 4 is brought into contact to the support layer 2.

For all the embodiments, the heating temperature is above the melting point of the binder composition. Preferably, the heating temperature is comprised between 90 and 170° C.

For all the embodiments when heat and pressure are used, the pressure is comprised between 0.25 and 5 bars, more preferably between 1 and 3 bars.

The contact of the impregnated fibre veil 3 and the support layer 2 may be performed by any suitable means, preferably by hot calendering, belt calendering, hot cylinders pressing, through-air thermal bonding, radiant-heat bonding or a combination thereof.

The PVC-free support layer 2, fibre veil 3, polymer-based binder composition, decorative layer 5 and transparent wear layer 4 are those described for the multiple layer PVC-free surface covering 1 according to the invention.

The terms “applying” and “applied” should be understood as covering any suitable process step wherein a layer is formed onto, or put in contact to, another layer.

### EXAMPLES

In all the examples (comparative examples and examples according to the invention), the surface covering 1 comprises:

a 1700 μm thick support layer 2 having a composition comprising 30% wt of VLDPE, 30% wt of POE, 30% wt of EVA, 10% wt of POE comprising anhydride groups (percentage in weight based on the total amount of the polyolefin resins), 20 phr of mineral oil, 300 phr of calcium carbonate, 2 phr of stearic acid, “Phr” meaning “Per Hundred Resin”, a proportion by weight in respect to 100 parts of the polymers,

a 200 μm thick transparent wear layer 4 made of two coextruded films, the first film being a 160 μm thick film made of an acid-based polymer neutralized or partially neutralised to form an ionomer, the second being a 40 μm thick EMAA-based film, the wear layer 4 being applied at around 180° C. for around 120 seconds,

The comparative examples comprise either no fibre veil 3, or a fibre veil 3 with no binder composition, and a fibre veil 3 comprising a polyolefin-based binder composition.

The examples according to the invention comprise a fibre veil 3 having different specific weight and comprising different concentration of binder composition.

For all the examples (comparative examples and examples according to the invention), the PVC compatible glue is a water based acrylic-based glue (Sadertac V6 from Bostik).

The adherence between the surface covering 1 and the surface to cover (the floor), are measured in a peeling test performed at 23° C. with a delamination angle of 90°. The glue is laid over concret at a thickness of around 0.3 mm at a concentration of 300 g/m² and is then allowed to dry at room temperature during 5 minutes. The PVC-free surface covering is then laid over the glue and is pressed using a “pressure roll” of around 30 kg and 50 cm width. The adherence of the PVC-free surface covering and the concret is measured after 10 days at 23° C.

TABLE 1
Comparative examples

| | | Binder | Thickness | Adherence |
|---|---|---|---|---|
| | Fibre Veil | composition | (μm) | (N/mm) |
| C1 | no | / | / | 0.1 |
| C2 | Polyester fibres 25 g/m² | no | 80 | 0.1 |
| C3 | Polyester fibres and | no | 100 | 0.1 |
| | Polyethylene fibres | | | |
| | 25 g/m² | | | |
| C4 | Polyester/co-polyamide | no | 200 | 0.1 |
| | fibres 30 g/m² | | | |

In table 1, the fibre veil comprising polyester fibres (C2) is Lutradur LD 7225 from Freudenberg, the fibre veil comprising polyester fibres and polyethylene fibres (C3) is LFB 20317 from Freudenberg and the fibre veil comprising polyester and co-polyester (C4) fibres is Colback WA 30 from Colbond.

In the comparative examples, the fibre veil 3 comprising the polymer-based binder composition is laminated with the support layer 2 at 1 bar, 145° C., during 30 seconds.

TABLE 2
Examples according to the invention

| | | | | Ratio | |
|---|---|---|---|---|---|
| | | Binder | Thickness | Binder/ | Adherence |
| | Fibre Veil | composition | (μm) | fibres | (N/mm) |
| 1 | Polyester | HDPE | 200-300 | 0.375 | 1.2 |
| | 40 g/m² | 15 g/m² | | | |
| 2 | Polyester | HDPE | 170-230 | 0.53 | 0.8 |
| | 17 g/m² | 9 g/m² | | | |

In table 2 the fibre veil comprising polyester fibers is Termoline 40286 and Termoline 17280 from Ipetex. The HDPE is N2805 from ICO polymers.

For these examples, the fibre veil 3 comprising the polymer-based binder composition is laminated with the support layer 2 at 1 bar, 145° C., during 30 seconds.

Taking into account that, an adherence under 0.3 N/mm is considered as being poor, an adherence between 0.3 and 0.6 N/mm is considered as being acceptable and an adherence of 1 N/mm or above 1 N/mm is considered as being ideal, from tables 1 and 2, it appears that a fibre veil comprising a binder composition has an enhanced adhesion in comparison to a fibre veil without such a binder composition. The adherence increases with the specific weight of the fibre veil and with the increase of the ratio weight of the binder composition/weight of the fibre veil.

The difference of thickness observed for the examples according to the invention is due to the difference of concentration and distribution within the fibre veil of the binder composition.

The influence of the nature of the binder composition, the nature of the fibre veil were studied and the results are given in tables 3 and 4. In these examples, the fibre veil 3 comprising the polymer-based binder composition is submitted to heat (145° C.) and pressure (1 bar) simultaneously while being brought into contact to the support layer 2. The influence of the pressure, at a fixed temperature of 145° C., was also studied and the results are given in table 5.

TABLE 3
Examples according to the invention

| | | | | Ratio | |
|---|---|---|---|---|---|
| | | Binder | | Binder/ | Adherence |
| | Fibre Veil | composition | MFI | fibres | (N/mm) |
| 3 | Polyester/co-polyamide | HDPE | 20 | 0.33 | 1.1 |
| | fibres 30 g/m² | 10 g/m² | | | |
| 4 | Polyester/co-polyamide | LLDPE | 20 | 0.33 | 1.1 |
| | fibres 30 g/m² | 20 g/m² | | | |
| 5 | Polyester/co-polyamide | LDPE | 21 | 0.33 | 1 |
| | fibres 30 g/m² | 10 g/m² | | | |
| 6 | Polyester/co-polyamide | POP | 30 | 0.33 | 1.2 |
| | fibres 30 g/m² | (d = 0.902) | | | |
| | | 10 g/m² | | | |
| 7 | Polyester/co-polyamide | EVA | 20 | 0.33 | 1.3 |
| | fibres 30 g/m² | 10 g/m² | | | |
| 8 | Polyester/co-polyamide | LDPE | 7.5 | 0.33 | 0.9 |
| | fibres 30 g/m² | 10 g/m² | | | |
| 9 | Polyester/co-polyamide | LDPE | 6.5 | 0.33 | 0.9 |
| | fibres 30 g/m² | 10 g/m² | | | |
| 10 | Polyester/co-polyamide | LDPE | 2 | 0.33 | 0.7 |
| | fibres 30 g/m² | 10 g/m² | | | |
| 11 | Polyester/co-polyamide | EVA | 20 | 0.13 | 0.5 |
| | fibres 30 g/m² | 4 g/m² | | | |
| 12 | Polyester/co-polyamide | EVA | 20 | 0.2 | 0.6 |
| | fibres 30 g/m² | 6 g/m² | | | |
| 13 | Polyester/co-polyamide | EVA | 20 | 0.26 | 0.8 |
| | fibres 30 g/m² | 8 g/m² | | | |
| 14 | Polyester/co-polyamide | EVA | 20 | 0.33 | 1 |
| | fibres 30 g/m² | 10 g/m² | | | |
| 15 | Polyester/co-polyamide | EVA | 20 | 0.5 | 1.2 |
| | fibres 30 g/m² | 15 g/m² | | | |

In table 3 the fibre veil is Colback WA 30 from Colbond. The HDPE is N2805, the LLDPE is N2301, the LDPE having a MFI of 21 g/10 min, 7.5 g/10 min, 6.5 g/10 min and 2 g/10 min is respectively N2105, N2102, N2103 and N2100, the POP is N2004 and EVA is N1009, all compounds being from ICO polymers.

For these examples, the fibre veil 3 comprising the polymer-based binder composition is laminated with the support layer 2 at 1 bar, 145° C., during 30 seconds.

TABLE 4
Examples according to the invention

| | | | | Ratio | |
|---|---|---|---|---|---|
| | | Binder | | Binder/ | Adherence |
| | Fibre Veil | composition | MFI | fibres | (N/mm) |
| 16 | Polyester | LDPE | 2 | 0.4 | 0.7 |
| | fibres 25 g/m² | 10 g/m² | | | |
| 17 | Polyester | LDPE | 2 | 0.5 | 0.9 |
| | fibres 25 g/m² | 12.5 g/m² | | | |
| 18 | Polyester | LDPE | 2 | 0.625 | 0.9 |
| | fibres 25 g/m² | 15 g/m² | | | |

In table 4, the fibre veil is Lutradur LD7225 from Freudenberg. The LDPE is N2100 from ICO polymers.

For these examples, the fibre veil 3 comprising the polymer-based binder composition is laminated with the support layer 2 at 1 bar, 145° C., during 30 seconds.

TABLE 5
Examples according to the invention

| | | Binder | | Pressure | Adherence |
|---|---|---|---|---|---|
| | Fibre Veil | composition | MFI | (bars) | (N/mm) |
| 19 | Polyester/co-polyamide | EVA | 20 | 0.25 | 0.7 |
| | fibres 30 g/m² | 8 g/m² | | | |
| 20 | Polyester/co-polyamide | EVA | 25 | 0.25 | 0.7 |
| | fibres 30 g/m² | 8 g/m² | | | |
| 21 | Polyester/co-polyamide | EVA | 45 | 0.25 | 0.9 |
| | fibres 30 g/m² | 8 g/m² | | | |
| 22 | Polyester/co-polyamide | EVA | 150 | 0.25 | 0.8 |
| | fibres 30 g/m² | 8 g/m² | | | |
| 23 | Polyester/co-polyamide | EVA | 400 | 0.25 | 0.7 |
| | fibres 30 g/m² | 8 g/m² | | | |
| 24 | Polyester/co-polyamide | EVA | 20 | 0.5 | 0.85 |
| | fibres 30 g/m² | 8 g/m² | | | |
| 13 | Polyester/co-polyamide | EVA | 20 | 1 | 0.8 |
| | fibres 30 g/m² | 8 g/m² | | | |
| 25 | Polyester/co-polyamide | EVA | 20 | 2 | 1.1 |
| | fibres 30 g/m² | 8 g/m² | | | |
| 26 | Polyester/co-polyamide | EVA | 20 | 3 | 1.1 |
| | fibres 30 g/m² | 8 g/m² | | | |
| 27 | Polyester/co-polyamide | EVA | 20 | 5 | 1.2 |
| | fibres 30 g/m² | 8 g/m² | | | |

In table 3, the fibre veil is Colback WA 30 from Colbond. The EVA having a MFI of 20 g/10 min, 25 g/10 min, 45 g/10 min, 150 g/10 min, 400 g/10 min is repectively N1009, N1012, N1014, N1016, N1013 from ICO polymers.

For these examples, the fibre veil 3 comprising the polymer-based binder composition is laminated with the support layer 2 at 145° C. during 30 seconds under the pressure given in the table.

TABLE 6
Examples according to the invention

| | | Binder | | Pressure | Adherence |
|---|---|---|---|---|---|
| | Fibre Veil | composition | MFI | (bars) | (N/mm) |
| 14 | Polyester/co-polyamide | EVA | 20 | 1 | 1 |
| | fibres 30 g/m² | 10 g/m² | | | |
| 28 | Polyester/co-polyamide | EVA | 20 | 1 | 0.9 |
| | fibres 50 g/m² | 10 g/m² | | | |
| 29 | Polyester/co-polyamide | EVA | 20 | 1 | 0.8 |
| | fibres 75 g/m² | 10 g/m² | | | |
| 30 | Polyester/co-polyamide | EVA | 20 | 1 | 1.1 |
| | fibres 50 g/m² | 15 g/m² | | | |
| 31 | Polyester/co-polyamide | EVA | 20 | 1 | 1 |
| | fibres 75 g/m² | 15 g/m² | | | |
| 32 | Polyester/co-polyamide | EVA | 20 | 1 | 1.1 |
| | fibres 75 g/m² | 20 g/m² | | | |
| 33 | Polyester/co-polyamide | EVA | 20 | 1 | 1.1 |
| | fibres 75 g/m² | 25 g/m² | | | |
| 34 | Polyester/co-polyamide | EVA | 20 | 0.5 | 1 |
| | fibres 75 g/m² | 25 g/m² | | | |

In table 6, the fibre veil 3 of 30 g/m², 50 g/m² and 75 g/m² are respectively Colback WA 30, Colback WA 50, Colback WA 75 from Colbond.

It appears that the fibre veil 3 having a specific weight comprised between 17 to 75 g/m2 and comprising a binder composition at a concentration comprised between 5 to g/m² enhance the adhesion between a PVC-free surface covering and the surface to cover when a PVC compatible glue is used.

A ratio weight of the binder composition/weight of the fibre veil 3 comprised between 0.13 and 0.625 allows getting an adherence considered as being acceptable to ideal.

Preferably, the ratio is comprised between 0.2 and 0.5, more preferably between 0.26 and 0.4.

The MFI of the binder composition is comprised between 2 and 400 g/10 min (measured at 190° C. under 2.16 kg), preferably between 6.5 and 150 g/10 min (measured at 190° C. under 2.16 kg) and more preferably between 7.5 and 40 g/10 min (measured at 190° C. under 2.16 kg).

The method for covering a surface comprises the steps of providing a multiple PVC-free substrate covering 1 according to the invention, providing a PVC compatible glue, laying said PVC compatible glue at a concentration comprised between 150 and 500 g/m², preferably 300 g/m², over the surface to cover before laying said PVC-free substrate covering over said PVC compatible glue.

Preferably, the multiple PVC-free substrate covering should be laid on the glue just after said glue has been applied on the surface to cover. However, generally in practice, the glue is applied over a wide surface before the surface covering is applied; in this case, the glue should not dry more than 15 minutes.

The PVC compatible glue may be neoprene-based or an acrylic-based glue.

The surface to cover may be an interior surface of a house or a building. The surface to cover may be a floor or a wall.

1. A multilayer PVC-free surface covering (1) comprising a PVC-free support layer (2) comprising a fibre veil (3) having a specific weight comprised between 17 to 75 g/m² on the side intended to contact, in use, the surface to cover, said fibre veil (3) comprising a polyolefin-based binder impregnation at a weight comprised between 5 to 25 g/m².

2. The multilayer PVC-free surface covering (1) according to claim 1, wherein the weight ratio of the binder composition/weight of the fibre veil 3 is comprised between 0.13 and 0.625, preferably between 0.2 to 0.375.

3. The multilayer PVC-free surface covering (1) according to claim 1, wherein the polyolefin-based binder impregnation comprises high density polyethylene (HDPE), low density polyethylene (LDPE) or linear low density polyethylene (LLDPE), very Low Density Polyethylene (VLDPE), ethylene vinyl acetate (EVA), polyolefin plastomers (POP), polyolefin elastomers (POE) or a combination thereof.

4. The multilayer PVC-free surface covering (1) according to claim 1, wherein the fibre veil (3) comprising the polyolefin-based binder impregnation has a thickness of less than 350 μm, preferably less than 250 μm.

5. The multilayer PVC-free surface covering (1) according to claim 1, wherein the PVC-free support layer (2) is a polyolefin-based layer.

6. The multilayer PVC-free surface covering (1) according to claim 5, wherein the PVC-free support layer (2) comprises a composition comprising ethylene vinyl acetate (EVA), ethyl methyl acrylate (EMA), ethylene butyl acrylate (EBA), very low density polyethylene (VLDPE), linear low density polyethylene (LLDPE), polyolefin plastomers (POP), polyolefin elastomers (POE) or a combination thereof.

7. The multilayer PVC-free surface covering (1) according to claim 1, further comprising a decorative layer (5) comprising a polyurethane water-based ink, and a polyolefin-based wear layer (4).

8. The multilayer PVC-free surface covering (1) according to claim 1, further comprising a polyurethane-based varnish layer (6) over a polyolefin-based wear layer (4).

9. Use of a fibre veil (3) having a specific weight comprised between 17 to 75 g/m², and comprising a polyolefin-based binder impregnation at a weight comprised between 5 to 25 g/m², to enhance the roughness of the back surface of a PVC-free support layer (2) or a surface covering comprising said a support layer (2).

10. Use of a fibre veil (3) having a specific weight comprised between 17 to 75 g/m², and comprising a polyolefin-based binder impregnation at a weight comprised between 5 to 25 g/m², to make a PVC-free support layer (2) of a multiple layer PVC-free surface covering (1) compatible with a PVC compatible glue, preferably an acrylic-based glue.

11. A method for producing a surface multiple layer PVC-free surface covering (1) comprising the steps of:
providing a fibre veil (3) having a specific weight comprised between 17 to 75 g/m² and impregnated with a polymer-based binder composition at a weight comprised between 5 to 25 g/m² or providing a fibre veil (3) having a specific weight comprised between 17 to 75 g/m² and spreading a polymer-based binder composition at a weight comprised between 5 to 25 g/m² over one side of said fibre veil (3),
providing a PVC-free support layer (2) or a multiple layer PVC-free surface covering (1) comprising a PVC-free support layer (2),
submitting to heat, or heat and pressure, the fibre veil (3) comprising the polymer-based binder composition before being, or simultaneously while being, brought into contact to the support layer (2) or the support layer (2) of multiple layer PVC-free surface covering (1).

12. The method according to claim 11, wherein the fibre veil (3) comprising the polymer-based binder composition is submitted to heat simultaneously while being put in contact with the support layer (2) and simultaneously while the wear layer (4) is brought into contact to the support layer (2).

13. The method according to claim 1, wherein the heating temperature is comprised between 90 and 170° C. and the pressure is comprised between 0.25 and 5 bars.

14. A method for covering a surface comprising the steps of:
providing a PVC compatible glue,
providing a multiple layer PVC-free surface covering (1) according to claim 1, applying said PVC compatible glue at a concentration comprised between 150 and 500 g/m² over the surface to cover to form a glue layer having a thickness comprised between 100 and 400 μm,
applying said multiple layer PVC-free surface covering (1) over said PVC compatible glue.

15. The method according to claim 14, wherein the time between the step of applying the PVC compatible glue and applying the multiple layer PVC-free surface covering should not exceed 15 minutes.
